(19) United States
(12) Patent Application Publication
(10) Pub. No.: US 2010/0270699 A1
(43) Pub. Date: Oct. 28, 2010

(54) INJECTION MOLD AND METHOD FOR MAKING A HOUSING USING THE INJECTION MOLD

(75) Inventors: Kun-Tsan Wu, Shindian (TW); Li-Wen Tien, Shindian (TW); Chuan-Bao Hong, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/834,026

(22) Filed: Jul. 12, 2010

Related U.S. Application Data
(63) Continuation-in-part of application No. 12/331,554, filed on Dec. 10, 2008.

(30) Foreign Application Priority Data
Mar. 14, 2008 (CN) 200810300586.8

(51) Int. Cl. B29C 51/36; B29C 45/14

(52) U.S. Cl. 264/101; 425/112; 264/265

(57) ABSTRACT

An injection mold includes a female mold and a male mold corresponding to the female mold. The female mold includes a first joining surface, a concave cavity, a receiving slot, and a angled portion. The concave cavity is defined in the first joining surface. The receiving slot is defined in the first joining surface surrounding the concave cavity. The angled portion is formed at a tip of a joint of the receiving slot and the concave cavity. The male mold includes a second joining surface, and a stationary cutting portion is directly fixed on the second joining surface. The cutting portion interdigitates with the angled portion when the injection mold is closed.

### CROSS-REFERENCE TO RELATED APPLICATION

This application is a continuation-in-part application of U.S. Ser. No. 12/331,554, filed Dec. 10, 2008, the contents of which are hereby incorporated by reference. The parent application Ser. No. 12/331,554 in turn claims the benefit of priority under 35 USC 119 from Chinese Patent Application 200810300586.8, filed on Mar. 14, 2008.

### BACKGROUND

1. Field of the Invention

The present disclosure relates to an injection mold and a method for making a housing using the injection mold and especially relates to an injection mold and a method for making a housing with a soft layer using the injection mold.

2. Description of Related Art

The housing is one of the main components of electronic devices, such as telephones, computers and etc. Because molded articles have advantages of being light, low cost and non-corrosive, housings for electronic devices are often made by injection molding.

To enable the housings to have a good touch feel, in the prior art, a soft layer, for example, leather or fabric is formed on the housing. When making such housing, the soft layer is firstly positioned into the mold. After injecting plastic material into the mold, the plastic material is cooled and attaches to the soft layer to form a semi-finished product. The semi-finished product is then removed from the mold and excess edges of the soft layer cut. However, the cutting process can be complicated, and the processing efficiency is low.

Therefore, there is room for improvement within the art.

### BRIEF DESCRIPTION OF THE DRAWINGS

FIG. 1 shows a cross-sectional view of an exemplary embodiment of the present injection mold in an opening state;

FIG. 2 shows a front elevational view of a female mold of the injection mold.

FIG. 3 shows a cross-sectional view of a housing making by the injection mold;

FIG. 4 shows a schematic view of a soft sheet put in the injection mold;

FIG. 5 shows a schematic view of the soft sheet adhering inside the injection mold;

FIG. 6 shows a schematic view of closing the injection mold to cut the soft sheet; and

FIG. 7 shows a schematic view of the injection mold injecting plastic material.

### DETAILED DESCRIPTION

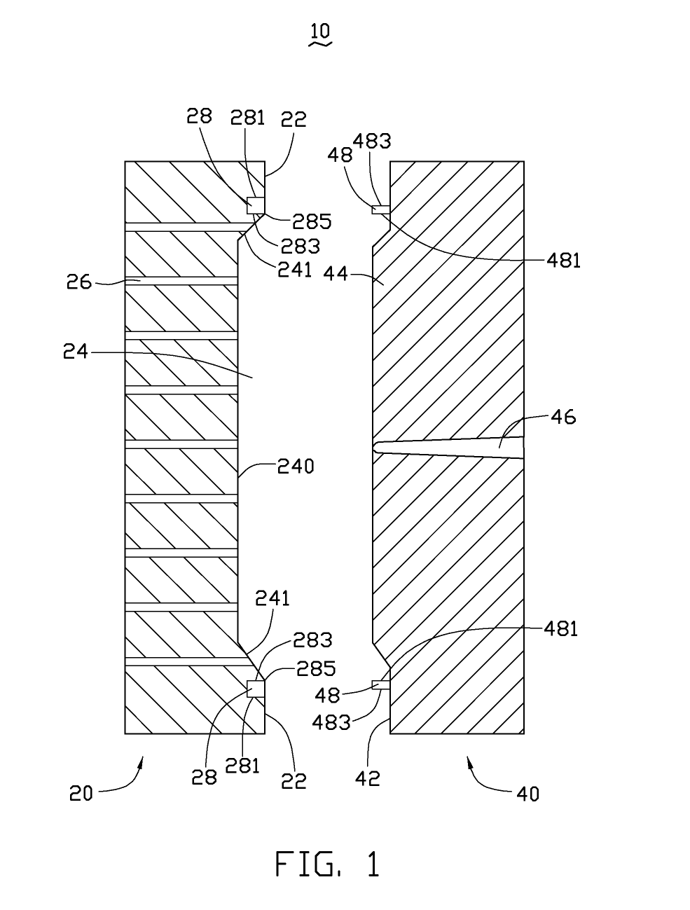

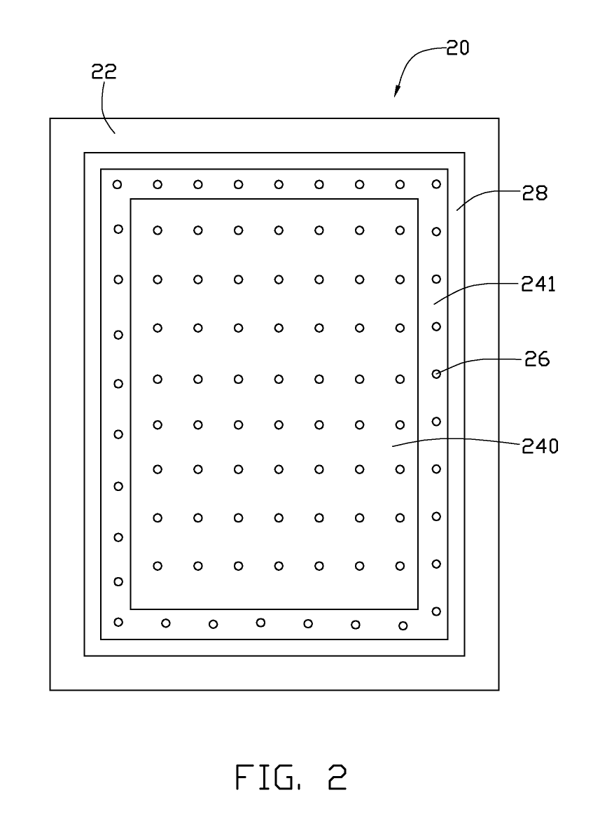

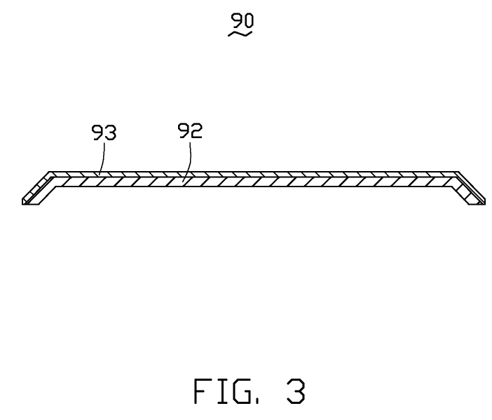

Referring to FIGS. 1 to 3, in an exemplary embodiment, an injection mold 10 is used to make a housing 90. The housing 90 includes a main body 92 and a soft layer 93 formed on the main body 92.

The injection mold 10 includes a female mold 20 and a male mold 40 corresponding to the female mold 20.

The female mold 20 includes a first joining surface 22 facing the male mold 40. A concave cavity 24 is defined in the first joining surface 22. A plurality of air suction holes 26 is defined in a bottom wall 240 and an angled sidewall 241 of the concave cavity 24, and the suction holes 26 extend through the female mold 20. Each air suction hole 26 communicates with the concave cavity 24. The first joining surface 22 defines a receiving slot 28 surrounding the concave cavity 24. The receiving slot 28 begins from the angled sidewall 241 of the concave cavity 24, and includes a first inner wall 281 and a second inner wall 283 facing the first inner wall 281. The second inner wall 283 intersects the angled sidewall 241. An angled portion 285 is formed at a tip of a joint of the second inner wall 283 and the angled sidewall 241. The angled portion 285 is triangular for easily cutting the a soft sheet 94 to the soft layer 93.

The male mold 40 includes a second joining surface 42 facing the female mold 20, a protruding portion 44 formed on the second joining surface 42, and at least a runner 46 extending through the male mold 40. The male mold 40 includes a stationary cutting portion 48 directly fixed on and extending from the second joining surface 42 and surrounding the protruding portion 44. When the injection mold 10 is closed, the second joining surface 42 comes close enough to the first joining surface 22 to form a clamping space. The cutting portion 48 may be received in the receiving slot 28. The cutting portion 48 may include blades. The cutting portion 48 is substantially a frame that surrounds the protruding portion 44, and includes a first surface 481 and an opposite second surface 483. The width of the cutting portion 48 is slightly smaller than the receiving slot 28, enabling the receiving slot 28 to accommodate the cutting portion 48. When the male mold 40 engages the female mold 20, the cutting portion 48 can interdigitate with the angled portion 285, and the first surface 481 tightly abut against/contact the second inner wall 283 of the receiving slot 28. Thus, excess portions of the soft sheet 94 can be cut by the angled portion 285 and the cutting portion 48 from two sides thereof to form the soft layer 93.

A method for making the housing 90 by using the injection mold 10 may include following steps:

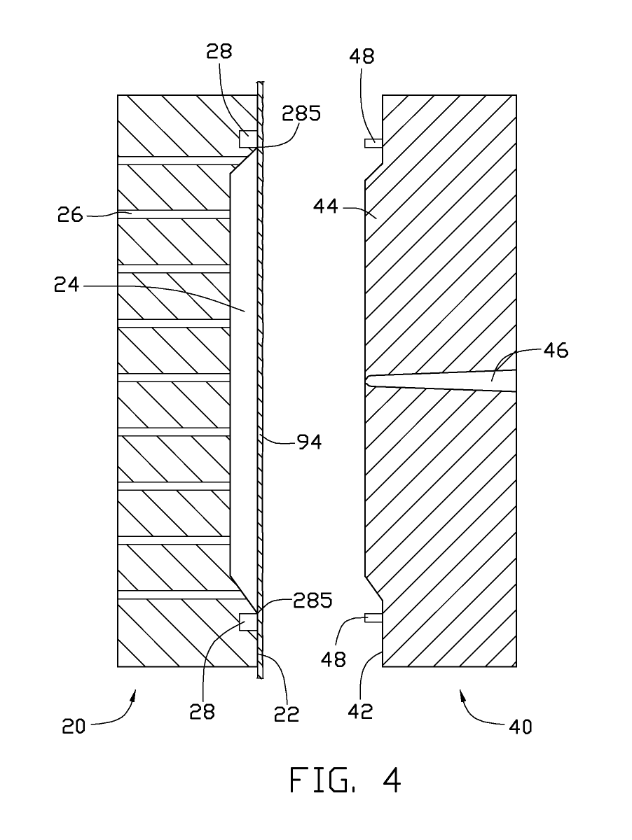

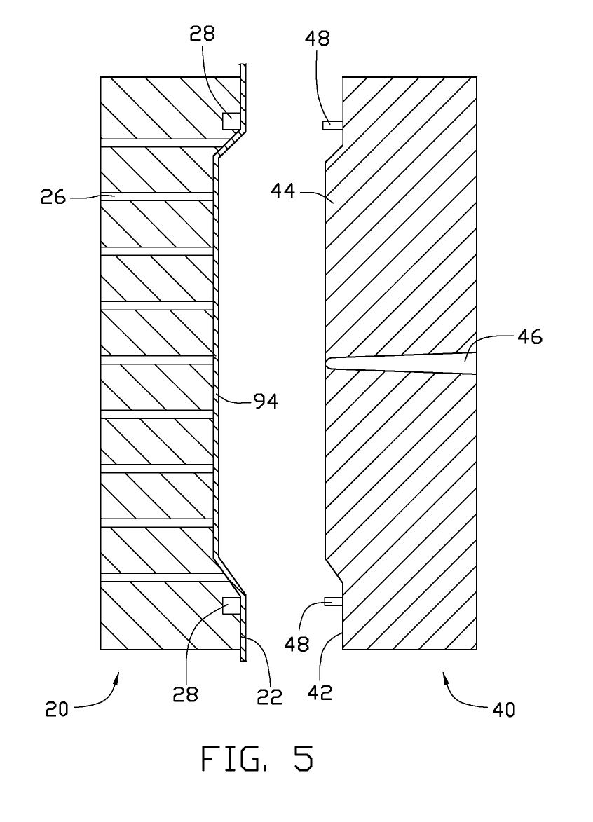

Referring to FIGS. 4 and 5, one part of the soft sheet 94 is put on the first joining surface 22 and encloses the concave cavity 24 and the receiving slot 28. Then, the soft sheet 93 is drawn against the concave cavity 24 by applying a vacuum to the concave cavity 24 through a plurality of air suction holes 26 communicating with a vacuum generator (not shown), thereby making the soft sheet 93 adhering to inside of the concave cavity 24 and contacting the bottom wall 240 and the angled sidewall 241. Meanwhile, the soft sheet 94 is pressed on the angled portion 285.

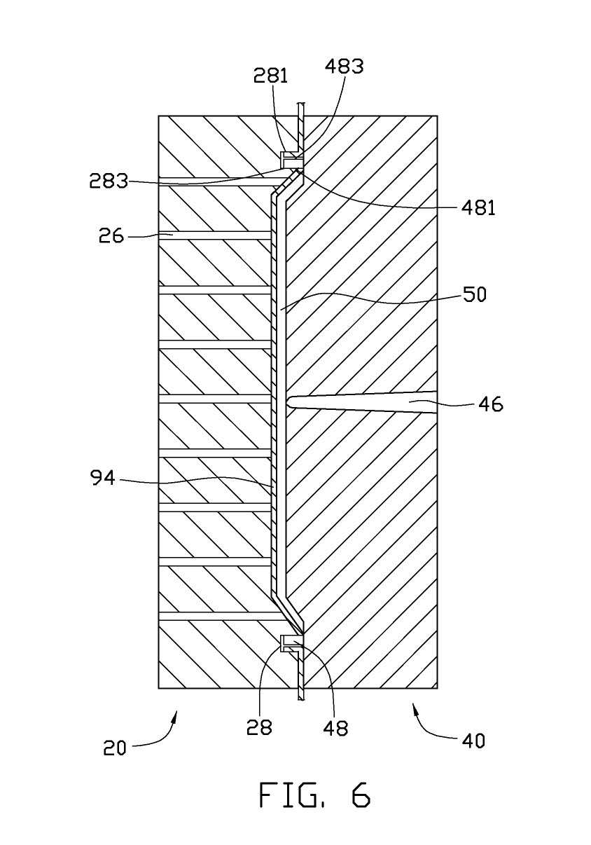

Referring to FIG. 6, the injection mold 10 is closed, and the cutting portion 48 of the male mold 40 is quickly moved toward the female mold 20 and the cutting portion 48 punches the soft sheet 94. The soft sheet 94 is cut by the cutting portion 48 and the angled portion 285 from two sides until the first surface 481 abuts against/contacts the second inner wall 283. Thus, the angled portion 285 and the first surface 481 cut excess edges of the soft sheet 94. After the soft sheet 94 is cut out, the soft layer 93 is formed, and the excess edges of the soft sheet 94 are clamped in the clamping space between the second surface 483 and the first inner wall 281. The male mold 40 and the female mold 20 define together a die chamber 50 therebetween.

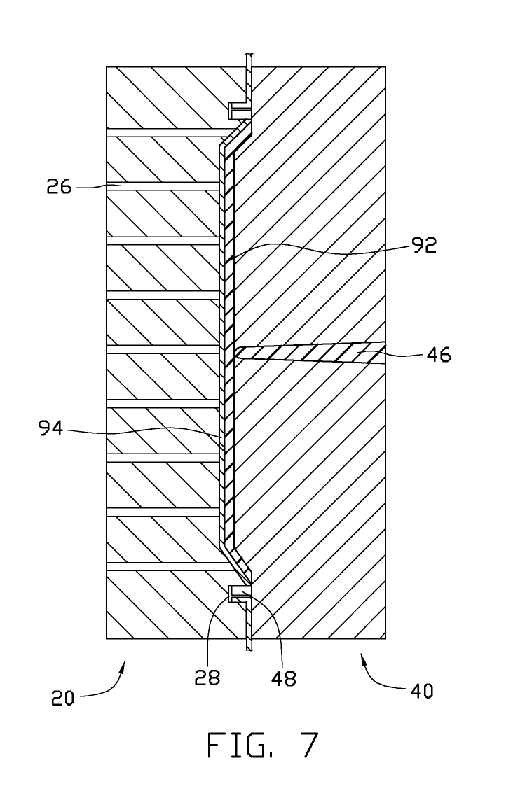

Referring to FIG. 7, melted material (e.g., plastic and/or silicone) is injected into the die chamber 50 through the runner 46 and attaches to the soft layer 93. The housing 90 with the soft layer 93 is complete.

After the housing 90 is cooled, the housing 90 is removed from the injection mold 10.

In a further embodiment, the cutting portion 48 can be positioned on the female mold 20, and a receiving slot 28 can be defined in the male mold 40 and configured for accommodating the cutting portion 48 on the female mold 20.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An injection mold for cutting a soft sheet comprising:
a female mold including a first joining surface, a concave cavity defined in the first joining surface, a receiving slot defined in the first joining surface surrounding the concave cavity, and an angled portion formed at a tip of a joint of the receiving slot and the concave cavity; and
a male mold corresponding to the female mold, the male mold including a second joining surface, and a cutting portion fixed on the second joining surface, wherein the cutting portion and the angled portion cut the soft sheet from two sides thereof.

2. The injection mold as claimed in claim 1, wherein the concave cavity includes a angled sidewall, the receiving slot includes a second inner wall intersecting to the angled sidewall; the angled portion is formed at a tip of a joint of the second inner wall and the angled sidewall.

3. The injection mold as claimed in claim 2, wherein the angled portion is triangular, the cutting portion includes a first surface for abutting against and contacting the second inner wall of the receiving slot.

4. The injection mold as claimed in claim 2, wherein the concave cavity includes a bottom connecting to the angled sidewall, a plurality of air suction holes are defined in the bottom and the angled sidewall.

5. The injection mold as claimed in claim 1, wherein the male mold includes a second joining surface facing the first joining surface, when the injection mold is closed, the first joining surface comes close enough to the second joining surface to form a clamping space.

6. A method for making a housing by an injection mold, comprising the steps of:
providing a female mold including a cutting portion and a male mold engaging with the female mold, the male mold defines a receiving slot and forms an angled portion adjacent the receiving slot;
placing a soft sheet on the female mold, closing the injection mold, whereby the cutting portion and the angled portion cutting the soft sheet from two sides thereof to form a soft layer, excess edges of the soft sheet clamped in the clamping space between the receiving slot and the cutting portion;
injecting melted plastic material into the injection mold, the melted plastic material attaching to the soft layer for forming a housing; and
removing the housing from the injection mold.

7. The method for making a housing by an injection mold as claimed in claim 6, wherein the female mold defines a concave cavity surrounded by the receiving slot, the concave cavity includes a angled sidewall, the receiving slot includes a second inner wall intersecting to the angled sidewall; the angled portion is formed at a tip of a joint of the second inner wall and the angled sidewall.

8. The method for making a housing by an injection mold as claimed in claim 7, wherein the angled portion is triangular, the cutting portion includes a first surface for abutting against and contacting the second inner wall of the receiving slot.

9. The method for making a housing by an injection mold as claimed in claim 7, wherein the concave cavity includes a bottom connecting to the angled sidewall, a plurality of air suction holes are defined in the bottom and the angled sidewall.

10. A method for making a housing by an injection mold, comprising the steps of:
providing an injection mold comprising:
a female mold including a first joining surface, a concave cavity defined in the first joining surface, a receiving slot defined in the first joining surface surrounding the concave cavity, an angled portion formed at a tip of a joint of the receiving slot and the concave cavity, and a plurality of air suction holes extending therethrough; and
a male mold corresponding to the female mold, the male mold including a second joining surface, and a cutting portion fixed on the second joining surface and for interdigitating with the angled portion when the mold is closed;
placing a soft sheet on the first joining surface of the female mold;
drawing the soft sheet against the concave cavity by the air suction holes to adgere the soft sheet inside of the concave cavity and covering the receiving slot;
closing the injection mold, the cutting portion interdigitating with the angled portion, the soft sheet being cut by the cutting portion and the angled portion from two sides thereof to form a soft layer, the excess edges of the soft sheet clamped in the clamping space between the receiving slot and the cutting portion;
injecting melted plastic material into the injection mold, the melted plastic material being attached to the soft layer for forming a housing; and
removing the housing from the injection mold.

11. The method for making a housing by an injection mold as claimed in claim 10, wherein the concave cavity includes a angled sidewall, the receiving slot includes a second inner wall intersecting to the angled sidewall; the angled portion is formed at a tip of a joint of the second inner wall and the angled sidewall.

12. The method for making a housing by an injection mold as claimed in claim 11, wherein the angled portion is triangular, the cutting portion includes a first surface abut against/contact the second inner wall of the receiving slot.

13. The method for making a housing by an injection mold as claimed in claim 11, wherein the concave cavity includes a bottom connecting to the angled sidewall, the air suction holes are defined in the bottom and the angled sidewall.

14. The method for making a housing by an injection mold as claimed in claim 10, wherein the male mold includes a second joining surface facing the first joining surface, when the injection mold is closed, the first joining surface contacts the second joining surface.
